(19) United States
(12) Patent Application Publication
(10) Pub. No.: US 2018/0204671 A1
(43) Pub. Date: Jul. 19, 2018

(54) Transformer Having Superconducting Windings

(71) Applicant: Siemens Aktiengesellschaft, Muenchen (DE)

(72) Inventors: Tabea Arndt, Erlangen (DE); Jörn Grundmann, Grossenseebach (DE); Christian Schacherer, Hallerndorf (DE)

(73) Assignee: Siemens Aktiengesellschaft, Muenchen (DE)

(21) Appl. No.: 15/742,713

(22) PCT Filed: Jul. 1, 2016
(86) PCT No.: PCT/EP2016/065454

§ 371 Date: Jan. 8, 2018

(30) Foreign Application Priority Data
Jul. 9, 2015 (DE) 10 2015 212 824.5

(51) Int. Cl. H01F 36/00; H01F 27/28; H01F 6/06; H01F 27/08

(52) U.S. Cl. CPC H01F 36/00; H01F 27/08; H01F 6/06; H01F 27/2895

(57) ABSTRACT

The present disclosure relates to transformers. Teachings thereof may be embodied in a transformation unit having a primary winding and a secondary winding. For example, a transformer may include: a first transformation unit with a primary winding and a secondary winding; and at least one high-temperature superconducting conductor in each of the two windings. Each of the two windings is wound around a first annular base structure common to both windings in a plurality of turns such that both of the two windings extend over a jointly-wrapped part of the circumferential extent of the annular base structure.

### CROSS-REFERENCE TO RELATED APPLICATIONS

This application is a U.S. National Stage Application of International Application No. PCT/EP2016/065454 filed Jul. 1, 2016, which designates the United States of America, and claims priority to DE Application No. 10 2015 212 824.5 filed Jul. 9, 2015, the contents of which are hereby incorporated by reference in their entirety.

### TECHNICAL FIELD

The present disclosure relates to transformers. Teachings thereof may be embodied in a transformation unit having a primary winding and a secondary winding.

### BACKGROUND

The majority of conventional transformers include electrical windings, which are arranged around a soft magnetic core, wherein said core is generally comprised of mutually electrically-insulated iron plates. Such transformers comprise at least a primary winding and a secondary winding, which are inductively coupled via a common soft magnetic core. The two windings of an electrical phase are generally arranged together around various segments of such a core. The conductor materials of the two windings can, in principle, be either normally-conducting or superconducting.

These conventional transformers with soft magnetic cores have various disadvantages:
The maximum useful magnetic field in the interior of the windings is limited by the magnetic field saturation of the soft magnetic material. In an iron core, the maximum useful magnetic field generally lies between 1.4 T and 2 T.
The material of the soft magnetic core accounts for a substantial proportion of both the weight and the costs of such a transformer. For mobile applications, and specifically for offshore applications, a significant reduction in the weight of a transformer would be desirable.
The stray field of a conventional transformer shows a substantial expansion, which can be associated, firstly with electrical losses, and secondly with problems of electromagnetic compatibility.

Transformers with superconducting windings do not necessarily need to be equipped with a soft magnetic core. As a result of superconducting properties, a high current can flow in the windings with virtually no ohmic losses and, in principle, very high magnetic fields can be generated, even in the absence of an iron core, without the occurrence of saturation effects. Superconducting transformers can at least be configured with a reduced quantity of soft magnetic material. Accordingly, at least the first two of the above-mentioned disadvantages can be eliminated or attenuated. However, known transformers with superconducting windings present further disadvantages or difficulties, which are associated with their design:
In an embodiment with a soft magnetic core, said core can also be arranged, together with the superconductor, in a region which is cooled to a cryogenic temperature. In this case, remagnetization losses occur under cold conditions, thereby increasing said losses in comparison with the remagnetization of a corresponding warm core, as the resistance of the core falls, and higher induction currents flow. Moreover, the degree of cooling required is thereby increased, as these remagnetization losses occur in a cold region.
Alternatively, a soft magnetic core can be arranged outside the region which is to be cooled. However, the design of a cryostat which is to be arranged around the superconducting windings will then be rendered significantly more complex, on the grounds that, firstly, an annular cryostat with a recess for the core is required and, secondly, at least in the region between the core and the coil winding, the cryostat wall, insofar as possible, should be configured of a non-electrically conductive material, in order to prevent additional electrical losses associated with eddy currents. In other regions, insofar as possible, the cryostat wall should also be configured of a non-conductive material, or the cryostat wall should be arranged with a substantial clearance from the windings, to minimize electrical losses. Alternatively, an electrically-conductive cryostat wall can also be interrupted, in a sub-region, by an insulating material, to suppress a closed annular current flux. However, the manufacture of a design of this type is relatively complex.

Low-temperature superconducting transformers are known, in which the primary winding and the secondary winding respectively are subdivided into a plurality of mutually series-connected part-windings, which are wound in an alternating sequence around an annular base structure. A transformer of this type is described, for example, by H. Hirczy in “Archie für Elektrotechnik” 55 (1972), pp 1-9. A multiple-interwound arrangement of this type prevents any excessive magnetic flux densities between the individual part-windings, thereby permitting alternating current losses in the individual superconducting conductor sections to be restricted. In a transformer with a low-temperature superconducting conductor material, an arrangement of this type is necessary as, in a coreless transformer, on the grounds of reduced permeability under otherwise equivalent conditions, a substantially higher number of windings must be provided. However, in comparison with individual, and non-radially-subdivided primary and secondary windings, this results in a significantly more complex design, with an increased complexity of windings and complexity of contacts, and an increased susceptibility to faults.

### SUMMARY

The teachings of the present disclosure may be embodied in a transformer which overcomes the above-mentioned disadvantages. Specifically, a transformer may be manufactured more simply and/or with the lowest possible weight. For example, some embodiments may include a transformer (1) comprising at least a first transformation unit (3) having a primary winding (5a) and a secondary winding (5b), wherein each of the two windings (5a, 5b) has at least one high-temperature superconducting conductor (7). Each of the two windings (5a, 5b) is wound around a first annular base structure (9a), which is common to both windings (5a, 5b), in a plurality of turns (Wi, Wi′), such that both windings (5a, 5b) extend over a jointly-wrapped, predominant part (u) of the circumferential extent of the annular base structure (9a).

In some embodiments, in the at least one transformation unit (3a) all the mutually electrically series-connected turns (Wi′) of one respective winding (5b) radially enclose all the mutually series-connected turns (Wi) of the other winding (5a) on the entire commonly-wound part (u) of the circumference.

In some embodiments, the inner of the two windings (5a, 5b), over a predominant proportion (u′) of the circumference of the first annular base structure (9a), is devoid of any soft magnetic core.

In some embodiments, the first annular base structure (9a) constitutes an open ring, with an axial offset (11) between the two end regions (13a, 13b) of the ring.

In some embodiments, the axial offset (11) is smaller than the diameter (15) of the first annular base structure (9a).

In some embodiments, a soft magnetic core (17) is arranged only in the end regions (13a, 13b) of the first annular base structure (9a) in the interior of the two windings (5a, 5b).

In some embodiments, there is a plurality of transformation units (3a, 3b, 3c), each having a primary winding (5a) and a secondary winding (5b) with high-temperature conductors (7). Each of the two windings (5a, 5b) of a respective transformation unit (3a, 3b, 3c) are wound in a plurality of turns (Wi, Wi′) around an annular base structure (9a, 9b, 9c) of the respective transformation unit (3a, 3b, 3c) which is common to both windings (5a, 5b). The two windings (5a, 5b) of a respective transformation unit (3a, 3b, 3c) extend over a commonly-wound and predominant proportion (u) of the circumference of the respective annular base structure (9a, 9b, 9c).

In some embodiments, all of the transformation units (3a, 3b, 3c) respectively incorporate an associated annular base structure (9a, 9b, 9c), which respectively constitutes an open ring with an axial offset (11) between the two end regions of the respective ring (9a, 9b, 9c). The individual annular base structures (9a, 9b, 9c) are configured in a mutually axially offset arrangement such that, in combination, they form a superordinate helix-type structure (19).

In some embodiments, there is a soft magnetic coupling yoke (17) which extends in the axial direction (a) in the region of the openings (12) of the axially-offset annular base structures (9a, 9b, 9c).

In some embodiments, there is a cryostat (21) for the cooling of the high-temperature superconducting conductors (7), wherein the cryostat (21) commonly encloses all the respective primary and secondary windings (5a, 5b) provided.

In some embodiments, the cryostat (21) assumes a simple and continuous topology.

In some embodiments, the cryostat (21) incorporates an electrically-conductive cryostat wall (23).

In some embodiments, the high-temperature superconducting conductors (7) comprises magnesium diboride and/or a compound of the REBCO type.

In some embodiments, the high-temperature superconducting electrical conductors (7) are configured as strip conductors (25).

In some embodiments, there is at least one winding carrier (27a) of annular design.

### BRIEF DESCRIPTION OF THE DRAWINGS

A number of exemplary embodiments of the teachings herein are described hereinafter, with reference to the attached drawings, in which:

FIG. 1 shows a schematic perspective view of parts of a transformer according to teachings of the present disclosure,

FIG. 2 shows a schematic perspective view of further parts of the transformer represented in FIG. 1,

FIG. 3 shows a schematic cross-sectional view of the annular base structure for the transformer represented in FIG. 2,

FIG. 4 shows a schematic perspective view of a transformer according to teachings of the present disclosure,

FIG. 5 shows a schematic perspective view of part of a transformer according to teachings of the present disclosure,

FIG. 6 shows further components of the transformer represented in FIG. 5,

FIG. 7 shows further components of the transformer represented in FIGS. 5 and 6, and

FIG. 8 shows a cryostat of the transformer represented in FIGS. 5 to 7.

### DETAILED DESCRIPTION

In some embodiments, an example transformer comprises at least a first transformation unit having a primary winding and a secondary winding. Each of the two windings has at least one high-temperature superconducting conductor. Each of the two windings is wound around a first annular base structure, which is common to both windings, in a plurality of turns, such that both windings extend over a jointly-wrapped, predominant part of the circumferential extent of the annular base structure.

An annular base structure is to be understood as a structure, the circumference of which constitutes a fully-closed ring, or which constitutes a ring which is open at one point in its circumference. In this case, for example, the two ends of the ring can be axially offset in relation to each other. In other words, the windings are arranged around a common toroidal base component. The two windings of the transformer are not arranged on different segments of the annular base component, but in a circumferential region which is common to both windings. Specifically, one of the windings entirely encloses the other in the common circumferential region.

In some embodiments, such a transformer has a significant advantage, in that the employment of a high-temperature superconducting conductor material permits a simple interwound arrangement. Thus, converse to the prior art, it is not necessary for the primary and secondary winding to be subdivided into further individual sub-interwound part-windings to achieve a tolerable level of alternating current losses at high currents and with high numbers of turns. This is attributable to the material properties of high-temperature superconductors, in which critical magnetic fields, conversely to low-temperature superconductors, are comparatively high.

Additionally, high-temperature superconductors are associated with a lower technical complexity of cooling, and higher losses can thus be tolerated in a cold environment than in the case of low-temperature superconductors. Moreover, as a result of the comparatively higher thermal capacities of high-temperature superconductors, higher localized power loss densities can be tolerated. This applies specifically, if the high-temperature superconducting windings are operating at a service temperature which lies below their critical temperature by a significant margin, for example more than 10° K below their critical temperature.

Thus, in the at least one transformation unit, all the mutually electrically series-connected turns of one winding can radially enclose all the mutually series-connected turns of the other winding on the entire commonly-wound part of the circumference. In other words, either the primary winding entirely encloses the secondary winding, or the secondary winding entirely encloses the primary winding, over the entire relevant circumferential region of the ring. The term “radial” is thus to be understood, not as the direction along the radius of the ring as a whole, but as the radial direction with respect to the local center of a cross-section of the ring. The expression to the effect that one winding “radially encloses” the other signifies that said winding, in any such cross-section, is arranged outside the other.

Other than the two windings described in the main claim, there are thus no further part-windings which are electrically connected in series with the two aforementioned windings, and are alternately interwound with the other respective winding type, as is required in low-temperature superconducting transformers according to the prior art.

The inner of the two windings, over a predominant proportion of the circumference of the first annular base structure, can be devoid of any soft magnetic core. Specifically, the jointly wrapped circumferential region or the annular base structure can be substantially devoid of any such soft magnetic core. In comparison with conventional transformers having normally conducting windings, such a transformer can be configured with a relatively low weight. It can thus be employed in mobile applications, for example in offshore applications, or in air travel.

A coreless or low-core design has a further advantage, in that the risk of a quench, i.e. the collapse of superconductivity, upon the initial magnetization of the transformer is reduced. In a conventional superconducting transformer with a soft magnetic core, as a result of the low ohmic resistance of the windings, very high currents occur in conjunction with the initial magnetization of the core (“rush-in currents”), which can result in a collapse of this type. In the form of embodiment with no magnetic core in the predominant part of the winding, this risk is significantly reduced.

In some embodiments, the first annular base structure may comprise an open ring, with an axial offset between the two end regions of the ring. In other words, this base structure can correspond to an individual winding of a helix. The arrangement of the windings on a common annular base structure may allow the magnetic flux to be delimited by the circumference of the ring, and only a limited stray magnetic field is present outside the ring.

In embodiments with an open ring, a stray magnetic field of this type is stronger in the region of the openings than in the remaining regions of the ring. As a result, the losses associated with this stray field can be somewhat higher than in the case of a completely closed ring. However, the open structure with an axial offset provides an advantage, in that the increased stray field at the openings can permit the achievement of a desired magnetic coupling of the above-mentioned first transformation unit with a further, axially-adjoining transformation unit.

Coupling of this type can be desired, for example, between multiple phases in a multi-phase alternating current network, to prevent any divergence of the individual phases, or the isolated interruption of individual phases, in the event of a load imbalance, single-phase loading, a short-circuit or any other malfunction in a superordinate electrical network. A magnetic equilibrium is thus established between the individual phases. Such a magnetic coupling of phases, for example, in a conventional three-phase transformer with a double-star connection, is achieved by means of an additional compensating winding.

In some embodiments of the first annular base structure with axial offset, this offset can be smaller than a diameter of the annular base structure. In some embodiments, the offset can be sufficiently small, such that the magnetic flux is substantially delimited by the superordinate annular structure and stray fields in the region of the ring opening are relatively weak, such that losses associated with these stray fields can also be kept low. In non-circular annular structures, the above-mentioned diameter is to be understood as the mean lateral external dimension of the ring.

In some embodiments with an open ring structure, a soft magnetic core in the interior of the two windings can be arranged only in the end regions of said structure. In other words, the remaining part of the circumference of the annular base structure can be devoid of a soft magnetic core, and such a core can be present only in the region of the openings, to permit, for example, magnetic coupling of the above-mentioned first transformation unit with an adjoining and further transformation unit of analogous design.

In some embodiments, the transformer may comprise a plurality of transformation units, each of which can be of analogous design to the first transformation unit described above. Such a multi-phase transformer can be employed, for example, in a three-phase alternating current network, to achieve a desired magnetic coupling of the individual phases.

In such a multi-phase transformer, all the transformation units can respectively incorporate an associated annular base structure, which respectively constitutes an open ring with an axial offset between the two end regions of the ring, wherein the individual annular base structures are configured in a mutually axially offset arrangement such that, in combination, they form a superordinate helix-type structure. In other words, one end region of a first annular base structure can be arranged opposite a first end region of an adjoining second annular base structure, and a second end region of the second annular base structure can, in turn, be arranged opposite a first end region of an adjoining third annular base structure, such that a superordinate helix-type structure is formed by all three ring structures. Thus, an axial offset between the two end regions of an open ring structure, for example, can approximately correspond to an axial offset between the individual adjoining annular structures. However, the axial offset, i.e. the axial opening in an individual ring, can also be somewhat larger than the axial offset between adjoining ring structures, to further increase magnetic coupling between the adjoining transformation units. In some embodiments, however, the axial opening in an individual ring can also be smaller than the axial offset between two adjoining ring structures, if a weaker magnetic coupling is desired.

Such a transformer, having a plurality of magnetically-coupled transformation units, can incorporate a soft magnetic coupling yoke, which extends in the axial direction in the region of the openings of the axially-offset annular base structures. An axially-extending coupling of this type is particularly appropriate for the achievement of the magnetic coupling of axially adjoining units, by means of the particularly pronounced stray magnetic field of the individual transformation units in the region of the openings. As a material, the coupling yoke may comprise iron, or be substantially comprised of iron. In some embodiments, the material can comprise metallic glasses (for example, amorphous iron) and/or nanocrystalline materials. Such materials are appropriate on the grounds of their high permeability and saturation polarization.

In some embodiments, an axially-extending coupling yoke of this type may be provided with projections in the region of the openings in the individual annular base structures, each of which projects inwards in an end region of the open annular structures. By means of such projections, the magnetic coupling of adjoining transformation units can be reinforced. Any propagation of stray magnetic fields from the regions of the openings in the annular structures to regions which are remote from the coupling yoke is thus prevented, as the magnetic flux is routed through the coupling yoke. Any propagation of stray magnetic fields in other spatial regions is reduced accordingly.

In some embodiments, the stronger magnetic coupling associated with projections on the coupling yoke is provided, in that the transition of the magnetic flux over a larger annular opening is possible, thus permitting the selection of a larger clearance between the end regions of the annular structure. As a result, the accessibility of the terminals of the two windings can be facilitated in that, for example, a larger opening can be provided for the outer winding than for the inner winding.

The transformer can incorporate a cryostat for the cooling of the high-temperature superconducting conductors, wherein the cryostat can commonly enclose all of the respective primary and secondary windings present. In some embodiments, only a single cryostat is required for the common cooling of all the superconducting windings of the transformer.

Such a cryostat may assume a simple and continuous topology. In other words, the cryostat is not configured as an annular cryostat, but assumes a simple and continuous structure, with no through-hole. In comparison with conventional superconducting transformers, in which annular cryostats are arranged around the annular windings and the interior of the windings lies outside the cryostat, the manufacture of a cryostat of this type can be substantially simpler. Moreover, it can be of a smaller design than cryostats having a complex topology.

In some embodiments, the cryostat may incorporate an electrically-conductive cryostat wall. In some embodiments, the cryostat wall, on a predominant portion of the outer surface of the cryostat, can be configured as an electrically-conductive wall. In some embodiments, this permits the use of metallic materials, such that a cryostat of this type can assume a comparatively robust design, in order to withstand repeated cooling cycles. In some embodiments, such a cryostat can be electrically non-conductive only in those regions located in proximity to openings in the annular base structure of the individual transformation units, to reduce electrical losses in these regions, which are associated with increased stray fields. In some embodiments, however, the cryostat wall can be configured as electrically-conductive over its entire surface.

In some embodiments, the cryostat may incorporate a cryostat wall of a magnetically-conductive material. Such a cryostat can contribute to the reduction of stray magnetic fields outside the cryostat, as the magnetic flux can be conducted via the cryostat. To permit the annular closure of the magnetic flux across the opening in an annular base structure, for example, a soft magnetic coupling yoke can be attached to an outer wall of the cryostat in the region of an opening in the annular structure.

In some embodiments, the high-temperature superconducting conductors of the primary and secondary windings can comprise magnesium diboride and/or a compound of the REBCO type. REBCO is an abbreviation for a compound of the REBa₂Cu₃Oₓ type, wherein RE stands for a rare earth element or a mixture of such elements.

Materials of this type are particularly suitable for application in transformers according to the present invention, as they show high critical current densities and high critical magnetic fields.

In some embodiments, the high-temperature superconducting conductor can generally be configured as a strip conductor. A strip conductor of this type can comprise, for example, a high-temperature superconducting layer applied to a normal conducting metallic substrate. In some embodiments, however, the substrate can also be non-conducting. In some embodiments, on both sides of the substrate and/or between the substrate and the superconducting layer, one or more additional layers can be arranged, for example buffer layers, electrical stabilizing layers, insulating layers and protective layers.

In general, the high-temperature superconducting layer may comprise a structure configured for the minimization of alternating current losses in the conductor. To this end, for example, the conductor can be subdivided into a plurality of conductor phases which, in the manner of a Roebel conductor, are transposed with a characteristic transposition length.

In some embodiments, the transformer can incorporate at least one winding carrier of annular design. Specifically, such a winding carrier can be provided for each transformation unit of such a transformer. The respective winding carrier, in its external form, can correspond to the respective annular base structure. Such a winding carrier can be respectively configured, for example, as a solid ring, around which the turns of the primary and secondary windings are wound. In a form of embodiment with an open ring structure, the end regions of such a winding carrier can be provided with recesses, into which the above-mentioned projections of a soft magnetic coupling yoke can project. In some embodiments, however, such a winding carrier can be configured as a hollow annular body over its entire circumference.

In general, a winding carrier may be formed of a non-electrically-conductive material to restrict electromagnetic losses in the winding carrier to a minimum.

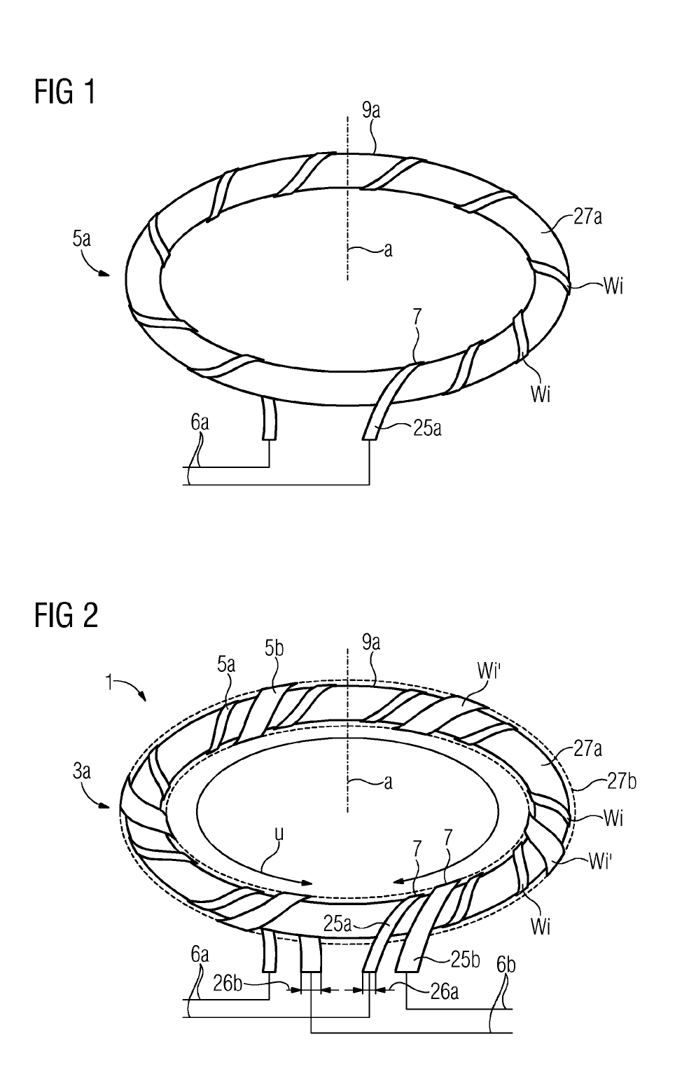

FIG. 1 shows a schematic perspective view of parts of a transformer according to teachings of the present disclosure. A winding carrier 27a is shown, which comprises an annular base structure 9a. In the first exemplary embodiment, this structure 9a corresponds to a closed ring or a torus. Although, in the example represented, the ring is a circular ring with a circular cross-section, other shapes are also conceivable, both for the superordinate form of the annular circumference and for the form of the annular cross-section, for example oval or elliptical shapes, polygons, or polygons with rounded corners. A primary winding 5a of the transformer is wound around the annular structure 9a, wherein said primary winding comprises a high-temperature superconducting conductor 7 which, in this example, is configured as a flat strip conductor 25a. This first strip conductor 25a is wound in a plurality of turns Wᵢ around the annular base structure 9a in the form of a toroidal winding which, in this case, is dictated by the first winding carrier 27a.

For the purposes of connection with an external circuit, the primary winding 5a may be provided with two contacts 6a, by means of which it can be connected, for example, to an alternating current source. The small number of turns Wᵢ shown in FIG. 1 are to be considered as an exemplary representation only and, where applicable, can represent a significantly higher number of turns. It is essential that these turns Wᵢ of the primary winding 5a are wound around the winding carrier 27a in a common inner radial winding layer. Optionally, this inner radial winding layer can also comprise a plurality of part-layers, which are wound one over another around the winding carrier 27a.

FIG. 2 shows the elements of the transformer 1 already represented in FIG. 1, together with further key elements of a first transformation unit 3a of the transformer. The transformer in this first exemplary embodiment can specifically comprise only one such transformation unit 3a, such that FIG. 2 represents all the key elements for the basic operation of the transformer 1. However, a plurality of such transformation units can also be present in a multi-phase transformer. Additionally to the elements shown in FIG. 1, FIG. 2 shows a second strip conductor 25b, which constitutes the secondary winding 5b of the transformer 1.

This secondary winding 5b likewise comprises two contacts 6b for connection to a superordinate secondary circuit, for example a load circuit. The secondary winding 6b is likewise wound around the same annular base structure 9a, such that a predominant part u of the circumference of the ring is wrapped in both the windings 5a and 5b. The secondary winding 5b is arranged such that, in comparison with the primary winding 5a with respect to a notional annular center of the base structure 9a, it is positioned further outwards. The secondary winding 5b is thus arranged in an outer radial winding layer, and entirely encloses the primary winding 5a in each segment of the annular circumference. In general, however, the sequential arrangement of the primary and secondary winding can also be reversed.

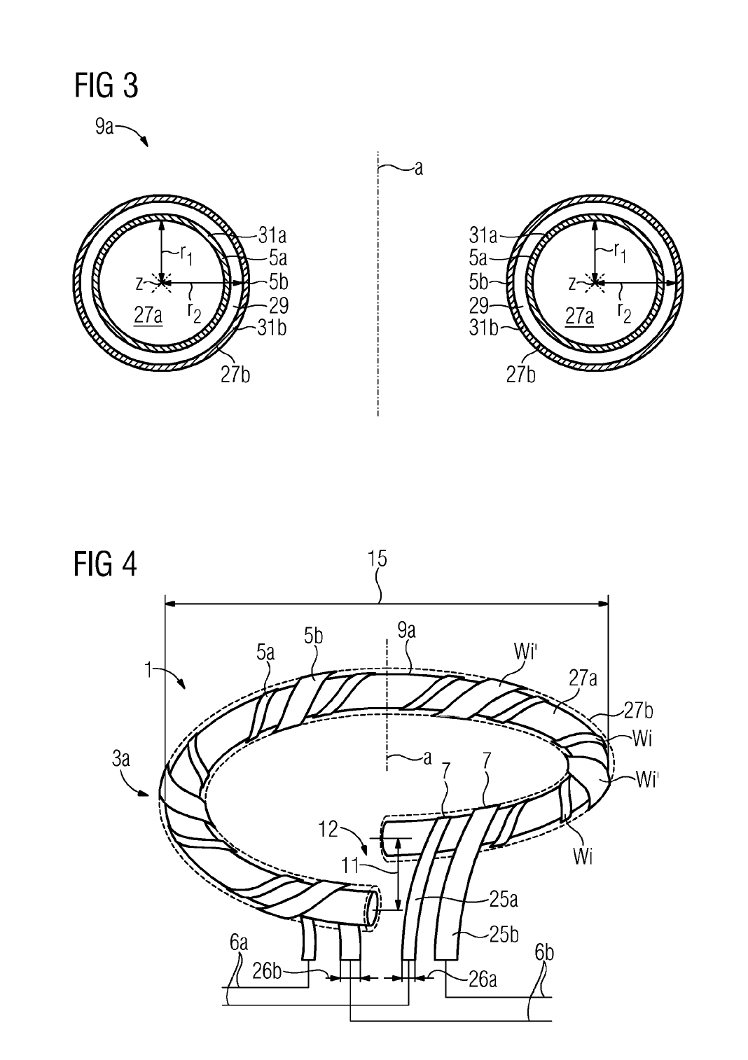

FIG. 3 clarifies these geometrical properties of the two interwound windings 5a and 5b. FIG. 3 thus shows a schematic cross-section of the annular base structure for the transformer 1 represented in FIG. 2, wherein the cross-sectional plane is positioned such that it encompasses the central axis a of the annular base structure 9a. The cross-section thus shows two opposing circumferential segments of the transformation unit 3a of the transformer 1, wherein the local center of each such segmental cross-section is identified by the letter z. With respect to this local center z, the primary winding 5a is thus wound around the winding carrier 27a in an inner winding layer 31a.

Here, the minimum inner radius of this inner winding layer 31a is dictated by the radius r₁ of this first winding carrier 27a. At the cross-section of a given circumferential position, this inner winding layer 31a is not completely occupied by the strip conductor of the primary winding 5a, wherein the layer only describes the radial region in which the turns Wᵢ of the primary winding 5a are located. With respect to the local center z, radially outside the inner winding layer 31a, in the example represented, an optional electrically-insulating intermediate layer 29 is arranged which, in this case, constitutes a second winding carrier 27b with a comparatively larger radius r₂. The position of this second winding carrier 27b is also identified in FIG. 2 by a dashed line.

However, it is not necessary for such an intermediate layer to be present. The secondary winding 5b can also be applied directly to the primary winding 5a, provided that the individual conductors 7 are sufficiently electrically insulated. It is essential that one winding 5b entirely radially encloses the other 5a with respect to the local center z of a given circumferential segment. Specifically, the primary winding 5a and the secondary winding 5b are not subdivided into part-windings, the radii of which are configured in an alternating arrangement of the two winding types.

Although a subdivision into part-windings within the respective winding layers 31a and 31b, which is not represented here, is entirely possible, all the part-windings of one winding type are arranged to entirely radially enclose all the part-windings of the other winding type. Conversely to the example represented in FIGS. 1 to 3, in principle, the primary winding 5a can also be arranged radially outside the secondary winding 5b. It is only essential that one winding entirely encloses the other, independently of the radial sequence.

In the operation of the transformer 1 represented in FIGS. 1 to 3, a current flowing in the primary winding 5a induces a current in the secondary winding 5b, wherein the ratio of currents and the ratio of voltages is given, in a known manner, by the ratio of the number of turns Wᵢ and Wᵢ′. The winding ratio of approximately 2:1 indicated here is to be understood as exemplary only. Depending upon the transformation ratio required, very different numerical ratios can be employed. Depending upon the direction of transformation, the secondary winding 5b, conversely to the example represented here, can have a higher number of turns than the primary winding 5a.

The two strip conductors 25a and 25b of the two windings 5a and 5b can generally be of similar or identical design, wherein they can comprise the same materials and/or can assume the same cross-sectional dimensions. In the case of an extreme turns ratio, however, some embodiments may include different cross-sectional areas and/or different materials for the two winding types. Thus, for example, as represented in FIG. 2, the winding 5b with the lower number of turns Wᵢ′ can have a larger conductor cross-section than the other winding 5a, as the higher current generally flows in the winding 5b with the lower number of turns Wᵢ′. Where a strip conductor 25a, 25b is used, the latter, for example, can assume a larger width to increase current-carrying capacity, whereby the remaining properties, specifically the constituent materials and vertical dimensions, may be configured as identical.

By means of the closed annular structure 9a of the first exemplary embodiment, it is achieved that, during the operation of the transformer, the magnetic flux in the interior windings 5a, 5b flows in an annular manner, and only a very limited stray field penetrates the radial region outside the two windings 5a and 5b. The interior of the annular base structure 9a can thus be devoid of a soft magnetic core. The inner winding carrier 27a can be comprised of a non-magnetic material. It can be configured, for example, as a solid ring, or as an annular hollow tube.

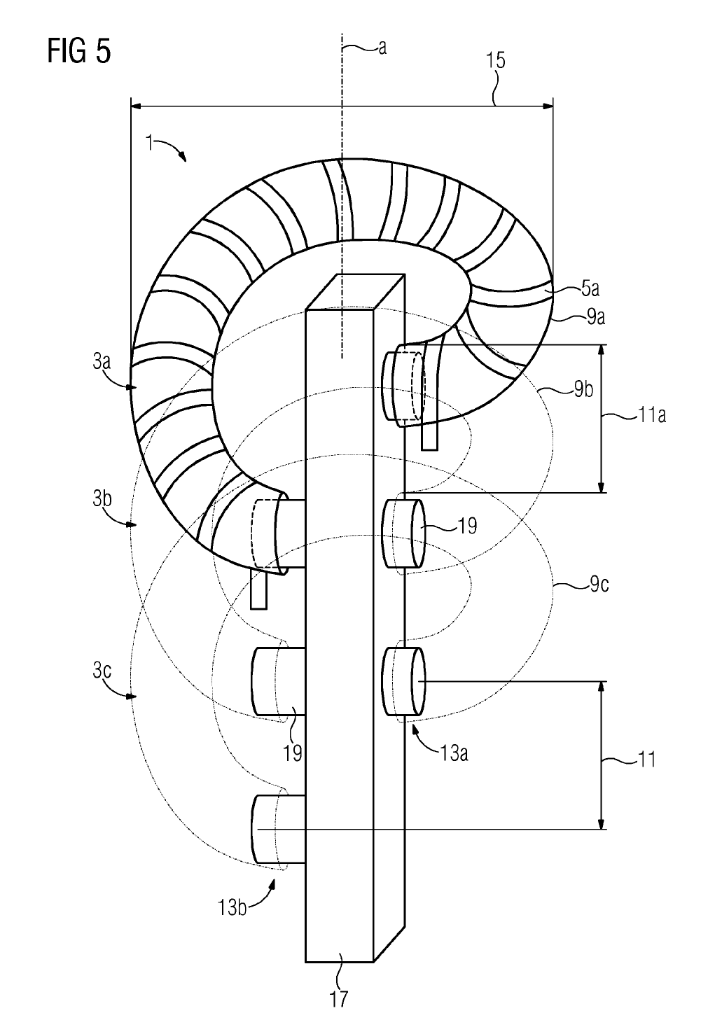

FIG. 4 shows a schematic perspective view of a further transformer 1 according to teachings of the present disclosure. Here again, only one transformation unit 3a is represented, wherein the entire transformer 1 can in turn be comprised of one or a plurality of such transformation units 3a. The exemplary embodiment shown in the figure is, in principle, of similar design to that represented in FIGS. 1 to 3. In a distinction from the first exemplary embodiment, however, an open annular base structure 9a is present in this case. Correspondingly, the first winding carrier 27a assumes the structure of a divided ring, having an opening 12.

With respect to its central axis a, the annular structure 9a shows an axial offset 11, which is small in comparison with an outer diameter 15 of the, in this case, circular ring 9a. Apart from this opening 12 and the axial offset 11, the remaining elements of the transformer are of similar design to the first exemplary embodiment. During the operation of the transformer 1 according to the second exemplary embodiment, however, the magnetic flux is not entirely enclosed within the annular base structure 9a but, in the region of the opening 12, an increased stray magnetic field is released from the ring structure proper. This increased stray magnetic field may be desirable to permit the achievement of the magnetic coupling of such a first transformation unit 3a with further transformation units of analogous design in a multi-phase transformer.

A multi-phase transformer of this type according to a third exemplary embodiment of the invention is shown in a schematic perspective representation in FIG. 5. Only selected elements of one transformer 1 are represented which, in this example, comprises three such transformation units 3a, 3b and 3c, each of which, for example, can be of similar design to that represented in FIG. 4. For the first transformation unit, in the interests of clarity, only one first open annular base structure 9a, with a primary winding 5a which encloses the latter, is represented. For the remaining two transformation units 3b and 3c, only the shapes of the open annular base structures 9b and 9c are represented. All three transformation units 3a, 3b and 3c are of analogous mutual design, and respectively comprise a secondary winding which locally radially encloses the primary winding. In principle, the radial sequence of primary and secondary windings can be exactly reversed. A different sequence can also be selected for the individual transformation units 3a, 3b and 3c.

The base structures 9a, 9b and 9c of the three transformation elements 3a, 3b and 3c, with respect to a superordinate system axis a of the transformer 1, are arranged with a mutual axial offset. In this exemplary embodiment, the axial offset 11a between two such adjoining units approximately corresponds to the inner axial offset 11 of a respective open ring. By means of this mutually appropriate selection of the two offsets 11a and 11, it is achieved that, for example, a second end region 13b of the first annular structure 9a is arranged in approximate opposition to a first end region 13a of the second annular structure 9b, and correspondingly for the second pair comprised of the second and third annular structures 9b and 9c. In this manner, the arrangement of the three annular structures 9a, 9b and 9c in the superordinate helix-type structure, which can be seen in FIG. 5, is produced.

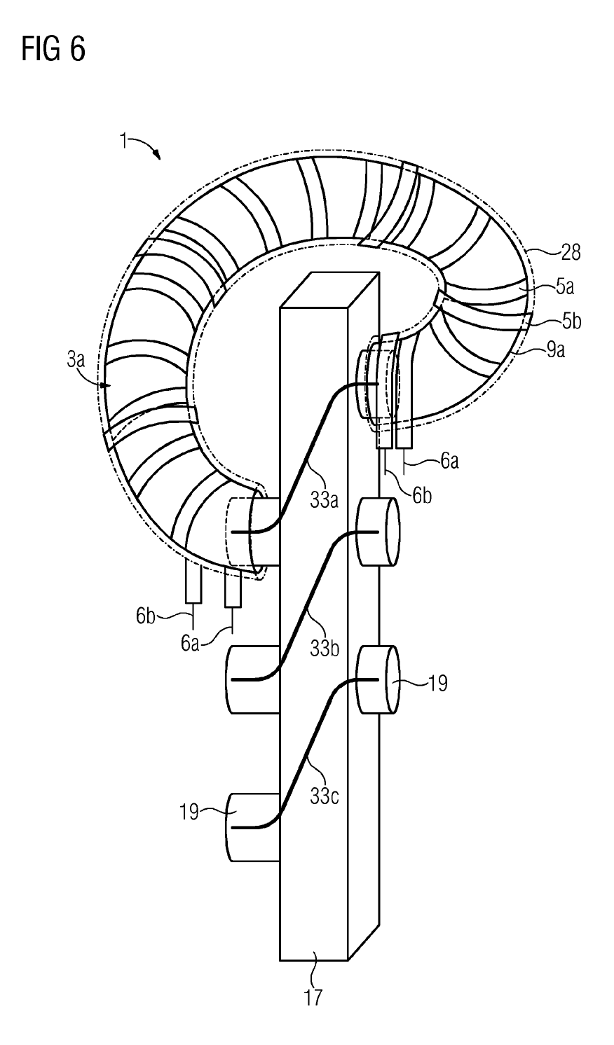

In addition to the three transformation units 9a, 9b and 9c, the transformer 1 in FIG. 5 incorporates a soft magnetic coupling yoke 17, which extends in the axial direction a of the system. The coupling yoke 17 is arranged such that it is positioned in the region of the openings 12 in the three open annular structures 9a, 9b and 9c. Accordingly, in the region of these openings 12, the magnetic flux which is discharged from the end regions 13a and 13b of the annular structures can be injected into the soft magnetic coupling yoke, thereby reinforcing the magnetic coupling of the adjoining transformation units. The corresponding path of the magnetic fluxes 33a, 33b and 33c for the three transformation units 3a, 3b and 3c is schematically represented in FIG. 6, which also shows the soft magnetic coupling yoke 17 of the same transformer 1 but, in the interests of clarity, without the winding carriers and the windings of the two lower transformation units 3b and 3c.

For the uppermost transformation unit 3a, additionally to the primary winding 5a already represented in FIG. 5, the enclosing secondary winding 5b is also represented which, in a similar manner to FIG. 4, is arranged as an enveloping structure 28 of the open annular base structure 9a.

The magnetic coupling yoke 17 incorporates six stud-like projections 19, which project into the end regions 13a and 13b of the three annular structures 9a, 9b and 9c, such that the injection of the magnetic flux into the coupling yoke 17 is further reinforced. However, even in the absence of such projections, the magnetic fluxes 33a, 33b and 33c of the three units will undergo a stronger mutual coupling via the soft magnetic material of the coupling yoke than would be the case in a corresponding geometrical arrangement with no such yoke. In principle, however, a similar magnetic coupling of a plurality of axially adjoining transformation units is also possible without the interposition of a soft magnetic material. The key element is that, by the axial offset 11 of the individual annular structures 9a, 9b and 9c, the magnetic fluxes 33a, 33b and 33c discharged in the region of the openings are in proximity to the respectively adjoining transformation units, and are thus magnetically coupled to the latter. Accordingly, in a multi-phase transformer of this type, a coupling of the phases may be achieved.

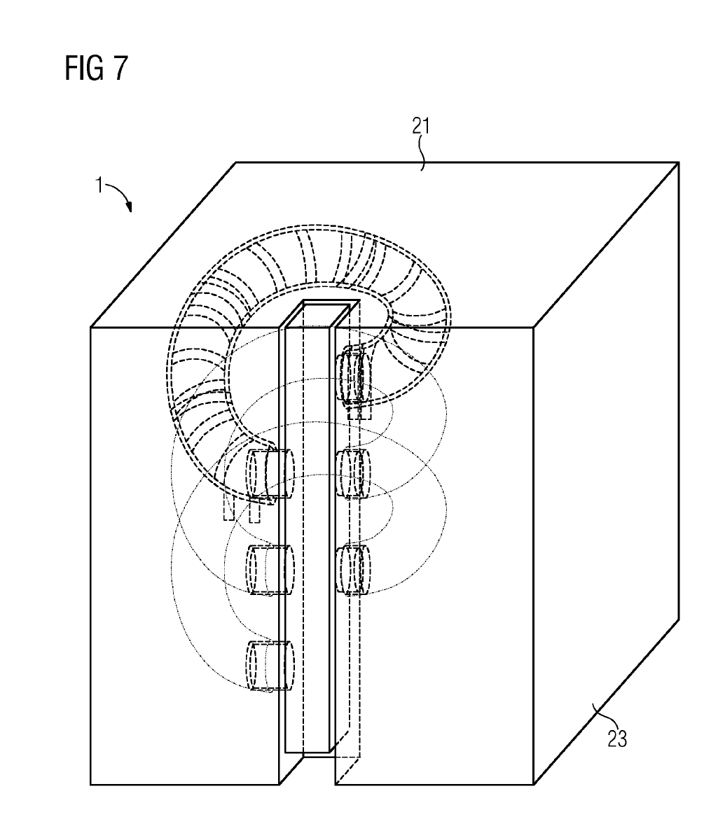

FIG. 7 shows a schematic perspective view of further components of the transformer 1 according to the third exemplary embodiment represented in FIGS. 5 and 6. In addition to the elements previously represented in FIG. 6, FIG. 7 shows a cryostat 21, which encloses all the primary and secondary windings of the three transformation units 3a, 3b and 3c. By means of this cryostat 21, the high-temperature superconducting windings 5a and 5b can be cooled to a cryogenic temperature below the critical temperature of the superconductor. The cryostat 21 is a closed, thermally-insulated container, by means of which the elements contained therein are thermally isolated from the warm external environment. This structure can be, for example, a bath cryostat. The outer cryostat wall 23 can be, for example, vacuum-insulated.

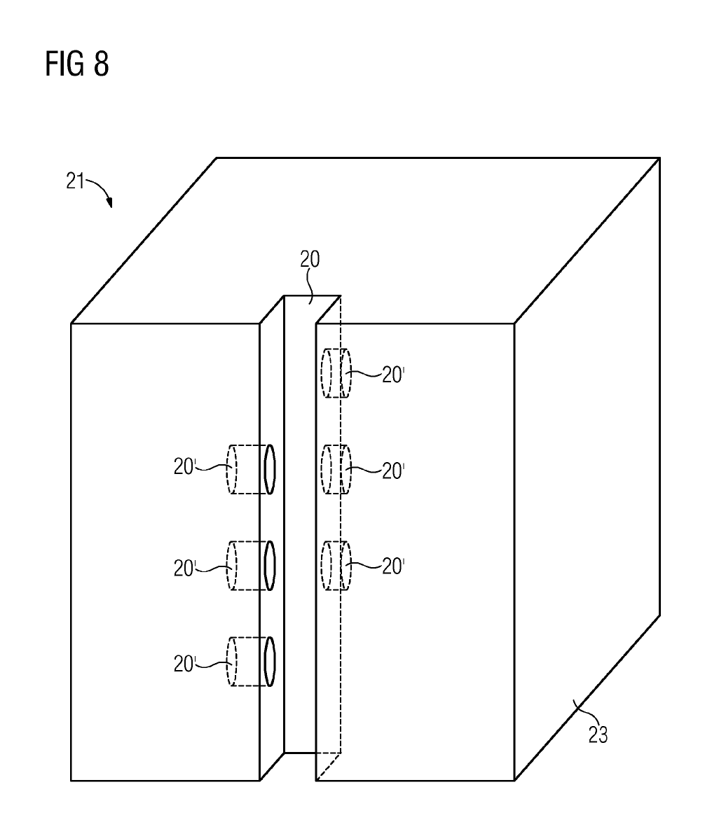

The cryostat 21 in FIG. 7 comprises an inner space having a simple and continuous topology, and is thus a simple chamber rather than an annular inner space. FIG. 8 shows a clearer overall view of the external outlines of the same cryostat 21, without the remaining elements of the transformer 1. In the region of the magnetic coupling yoke 17, the cryostat 21 is provided with a recess, such that said coupling yoke 17 can advantageously be arranged in a warm environment. In a branched arrangement from this recess 20, which is oriented in the axial direction a, further recesses 20′ are arranged, which are formed in a manner to accommodate the lateral projections 19 on the coupling yoke 17.

Although the cryostat represented in FIGS. 7 and 8 has a cube-shaped base structure, it can, in principle, assume other shapes such as, for example, a different cylindrical structure, the base surface of which is adapted to the shape of the individual transformation units. The outer wall 23 of the cryostat 21 can comprise an electrically-conductive material, for example a metallic material. For example, a major proportion of the outer surface of the outer wall 23 can be comprised of such an electrically-conductive material, and only be constituted of a non-electrically-conductive material in the region of the recesses 20 and/or 20′ to minimize losses associated with the penetration of the magnetic fluxes 33a, 33b and 33c through the cryostat wall 23 in the region of the annular openings 12.

What is claimed is:

1. A transformer comprising:
a first transformation unit with a primary winding and a secondary winding; and
at least one high-temperature superconducting conductor in each of the two windings;
wherein each of the two windings is wound around a first annular base structure common to both windings in a plurality of turns such that both of the two windings extend over a jointly-wrapped part of the circumferential extent of the annular base structure.

2. The transformer as claimed in claim 1, wherein, in the first transformation unit all the mutually electrically series-connected turns of one respective winding radially enclose all the mutually series-connected turns of the other winding on the entire jointly-wrapped part of the circumference.

3. A transformer as claimed in claim 1, wherein the inner of the two windings over a proportion of the circumference of the first annular base structure is devoid of any soft magnetic core.

4. A transformer according to claim 1, wherein the first annular base structure comprises an open ring with an axial offset between two end regions of the ring.

5. A transformer as claimed in claim 4, wherein the axial offset is smaller than a diameter of the first annular base structure.

6. A transformer as claimed in claim 4, wherein a soft magnetic core is arranged only in the end regions of the first annular base structure in the interior of the two windings.

7. A transformer as claimed in claim 1, comprising:
a plurality of transformation units, each having a primary winding and a secondary winding with high-temperature superconductors;
wherein each of the two windings of a respective transformation unit are wound in a plurality of turns around an annular base structure of the respective transformation unit which is common to both windings;
such that both of the two windings of a respective transformation unit extend over a commonly-wound proportion of the circumference of the respective annular base structure.

8. A transformer as claimed in claim 7, wherein all of the transformation units respectively incorporate an associated annular base structure, comprising an open ring with an axial offset between the two end regions of the respective ring;
wherein the individual annular base structures are arrayed in a mutually axially offset arrangement such that, in combination, they form a superordinate helix-type structure.

9. A transformer as claimed in claim 8, further comprising a soft magnetic coupling yoke extending in the axial direction in the region of the openings of the axially-offset annular base structures.

10. A transformer as claimed in claim 1, further comprising a cryostat for cooling of the high-temperature superconducting conductors, wherein the cryostat commonly encloses all the respective primary and secondary windings provided.

11. A transformer as claimed in claim 10, wherein the cryostat has a simple and continuous topology.

12. A transformer as claimed in claim 10, wherein the cryostat comprises an electrically-conductive cryostat wall.

13. A transformer as claimed in claim 1, wherein the high-temperature superconducting conductors comprises magnesium diboride and/or a REBCO compound.

14. A transformer as claimed in claim 1, wherein the high-temperature superconducting electrical conductors comprise strip conductors.

15. A transformer as claimed in claim 1, further comprising an annular winding carrier.
